(19) United States
(12) Patent Application Publication
(10) Pub. No.: US 2020/0243875 A1
(43) Pub. Date: Jul. 30, 2020

(54) POROUS MOLDING FOR AN ELECTROCHEMICAL MODULE

(71) Applicant: PLANSEE SE, REUTTE (AT)

(72) Inventors: CHRISTIAN BIENERT, REUTTE (AT); WOLFGANG SCHAFBAUER, REUTTE (AT); MARCO BRANDNER, REUTTE (AT)

(21) Appl. No.: 16/494,397

(22) PCT Filed: Feb. 22, 2018
(86) PCT No.: PCT/AT2018/000007

§ 371 Date: Sep. 16, 2019

(30) Foreign Application Priority Data
Mar. 16, 2017 (AT) GM 54/2017

(51) Int. Cl. H01M 8/0232; H01M 8/1231; H01M 8/2425; H01M 8/0258; H01M 8/026; H01M 8/0273; H01M 8/0612; H01M 8/0662

(52) U.S. Cl. CPC H01M 8/0232; H01M 8/1231; H01M 8/2425; H01M 8/0258; H01M 2008/1293; H01M 8/0273; H01M 8/0625; H01M 8/0662; H01M 8/026

(57) ABSTRACT

A porous molding for an electrochemical module. The electro-chemical module has at least one electrochemical cell unit having a layer construction with at least one electrochemically active layer, and a metallic, gastight housing which forms a gastight process gas space with the electrochemical cell unit. The housing extends on at least one side beyond the region of the electrochemical cell unit, and forms a process gas conduction space open to the electrochemical cell unit, and in the region of the process gas conduction space has at least one gas passage opening for the supply and/or removal of the process gases. The porous molding is formed as a separate component of the electrochemical cell unit and is configured for arrangement within the process gas conduction space and also for support of the housing on both sides along a stack direction of the electrochemical module.

The present invention relates to a porous molding for arrangement in an electrochemical module according to claim 1 and to an electrochemical module according to claim 13.

The porous molding of the invention is used in an electrochemical module which can be employed as, among other things, a high-temperature fuel cell or solid oxide fuel cell (SOFC), as a solid oxide electrolysis cell (SOEC; solid oxide electrolyser cell) and also as a reversible solid oxide fuel cell (R-SOFC). In the basic configuration, an electrochemically active cell of the electrochemical module comprises a gastight solid-state electrolyte which is arranged between a gas-permeable anode and a gas-permeable cathode. The electrochemically active components here, such as anode, electrolyte and cathode, are frequently designed as comparatively thin layers. A mechanical support function needed as a result may be provided by one of the electrochemically active layers, such as by the electrolyte, the anode or the cathode, for example, which in that case are each designed with corresponding thickness (in these cases, the system is referred to as an electrolyte-, anode- or cathode-supported cell, respectively), or by a component designed separately from these functional layers, such as a ceramic or metallic support substrate, for example. In the case of the latter approach, with a metallic support substrate designed separately, the system is referred to as a metal substrate-supported cell (MSC; metal-supported cell). Given the fact that in the case of an MSC, the electrolyte, whose electrical resistance falls as the thickness decreases and the temperature increases, can be given a comparatively thin design (e.g. with a thickness in the range from 2 to 10 μm), MSCs can be operated at a comparatively low operating temperature of around 600° C. to 800° C. (whereas, for example, electrolyte-supported cells are operated in some cases at operating temperatures of up to 1000° C.). On account of their specific advantages, MSCs are suitable in particular for mobile applications, such as, for example, for the electrical supply of passenger cars or commercial vehicles (APU—auxiliary power unit).

The electrochemically active cell units are customarily designed as planer individual elements, which are arranged one above another in connection with corresponding (metallic) housing parts (e.g. interconnector, frame panel, gas lines, etc.) to form a stack, and are electrically contacted in series. Corresponding housing parts, in the individual cells of the stack, bring about the supply of the process gases separately from one another in each case—in the case of a fuel cell, the supply of the fuel to the anode and of the oxidant to the cathode—and also the removal, on the anode side and cathode side, of the gases formed in the electrochemical reaction.

Based on a single electrochemical cell, a process gas space is formed in each case on either side of the electrolyte within the stack. The stack may be configured in a closed construction, in which the two process gas spaces, bounded in each case by the electrolyte and corresponding housing parts (interconnector, optionally also by a frame panel or else, in the case of MSCs, by the edge region of the support substrate), are sealed off in a gastight manner. For the stack it is also possible to realize an open construction, in which case only one process gas space is sealed off in a gastight manner, the anode-side process gas space, for example, in which the fuel is supplied and/or the reaction product is taken off, in the case of a fuel cell, while the oxidant (oxygen, air), for example, flows freely through the stack. Gas passage openings, which may, for example, be integrated into the frame panel, the interconnector or else, in the case of MSCs, into the edge region of the support substrate, serve here for the supply and removal of the process gases into and out of the sealed-off process gas space, respectively. EP 1 278 259 B1 describes by way of example a stack arrangement in open construction for an MSC.

For the function of the stack it is essential that the various process gas spaces are gastightly separated reliably from one another and that this gastight separation is maintained even under mechanical loading and at the cyclically fluctuating temperatures which occur in operation. Particularly during the manufacture of a stack, high pressure loads occur in the edge region as the modules are being pressed against one another, and these loads can lead to instances of deflection and cracking at weld seams, thereby jeopardizing the gastight status.

Important to the efficiency of the electrochemical module is a uniform flow of the process gases onto the electrochemically active layers and, respectively, a uniform removal of the reaction gases formed. The pressure drop is preferably to be no more than a small one. While the various electrochemical modules within the stack are supplied in the vertical direction by corresponding channel structures, the supply within an electrochemical module in the horizontal direction is accomplished by distribution structures which are usually integrated into the interconnector. Interconnectors, which also have the function of electrically contacting adjacent electrochemical cell units, have gas conduction structures for this purpose on both sides, and these structures may have, for example, a knob-shaped, rib-shaped or wave-shaped design. For many applications, the interconnector is formed by an appropriately shaped metallic sheet part, which, in analogy to other components in the stack, is where possible extremely thin for the purpose of weight optimization. In the case of mechanical stresses of the kind occurring during joining or in the operation of the stack, particularly at the edge region, this thin configuration may easily lead to instances of deformation and may therefore be extremely deleterious in terms of the requisite gastight status.

Accordingly, the object of the present invention lies in the cost-effective provision of an electrochemical module and of a molding for use within the process gas space of an electrochemical module, for which the gastight status of the process gas space of the electrochemical module is ensured over long service periods and even under mechanical loading and temperature fluctuations. Onward developments of the electrochemical module are to be distinguished, moreover, by advantageous gas guidance properties; in other words, the aim is to achieve an extremely uniform, small drop in pressure of the process gases within the process gas space, so that the distribution of the process gases over the flat electrochemical cell unit is as uniform as possible.

This object is achieved by the molding according to claim 1, the use of a molding according to claim 12, and an electrochemical module according to claim 13. Advantageous refinements are set forth in the dependent claims.

The molding of the invention is used for an electrochemical module which can be employed as a high-temperature fuel cell or solid oxide fuel cell (SOFC), as a solid oxide electrolysis cell (SOEC; solid oxide electrolyzer cell) and also as a reversible solid oxide fuel cell (R-SOFC). The basic construction of an electrochemical module of this kind features an electrochemical cell unit which has a layer construction with at least one electrochemically active layer and may also include a support substrate. Electrochemically active layers are understood here to refer, among others, to an anode, electrolyte or cathode layer, and the layer construction may optionally have further layers as well (made, for example, of cerium gadolinium oxide between electrolyte and cathode). Not all the electrochemically active layers must be present here; instead, the layer construction may also have only one electrochemically active layer (e.g. the anode), preferably two electrochemically active layers (e.g. anode and electrolyte), and the further layers, particularly those for completing an electrochemical cell unit, may not be applied until subsequently. The electrochemical cell unit may be designed as an electrolyte-supported cell, an anode-supported cell or as a cathode-supported cell (the layer giving the cell its name has a thicker configuration and takes on a mechanically load-bearing function). In the case of a metal substrate-supported cell (MSC), a preferred embodiment of the invention, the layer stack is arranged on a porous, plate-shaped, metallic support substrate having a preferred thickness typically in the range from 170 μm to 1.5 mm, more particularly in the range from 250 μm to 800 μm, in a gas-permeable, central region. The support substrate in this case forms part of the electrochemical cell unit. The layers of the layer stack are applied in a known way preferably by PVD (PVD: physical vapour deposition), such as, for example, by sputtering, and/or by thermal coating methods such as, for example, flame spraying or plasma spraying, and/or by wet-chemical methods such as, for example, screen printing, wet powder coating, etc.; for the realization of the overall layer construction of an electrochemical cell unit, it is also possible for two or more of these methods to be combined. Customarily, the anode is the electrochemically active layer immediately following the support substrate, while the cathode is formed on the side of the electrolyte remote from the support substrate. Alternatively, however, an inverted arrangement of the two electrodes is also possible.

Not only the anode (formed in the case of an MSC, for example, from a composite consisting of nickel and of zirconium dioxide fully stabilized with yttrium oxide) but also the cathode (formed in the case of an MSC, for example, from perovskites with mixed conductivity such as (La,Sr)(Co,Fe)O₃) have a gas-permeable design. Formed between anode and cathode is a gastight solid electrolyte comprising a solid, ceramic material made of metal oxide (e.g. of zirconium dioxide fully stabilized with yttrium oxide), which is conductive for oxygen ions, but not for electrons. Alternatively, the solid electrolyte may also be conductive for protons, with this relating to a more recent generation of SOFCs (e.g. solid electrolyte of metal oxide, more particularly of barium zirconium oxide, barium cerium oxide, lanthanum tungsten oxide or lanthanum niobium oxide).

The electrochemical module additionally has at least one metallic, gastight housing, which forms a gastight process gas space with the electrochemical cell unit. In the region of the electrochemical cell unit, the process gas space is bounded by the gastight electrolyte. On the opposite side, the process gas space is customarily bounded by the interconnector, which for the purposes of the present invention is also considered to be part of the housing. The interconnector is connected in gastight manner to the gastight element of the electrochemical cell unit, optionally in combination with additional housing parts, more particularly circumscribing frame panels or the like, which form the rest of the delimitation of the process gas space. In the case of MSCs, the gastight attachment of the interconnector is accomplished preferably by means of soldered connections and/or welded connections via additional housing parts, examples being circumscribing frame panels, which in turn are connected in a gastight manner to the support substrate and accordingly, together with the gastight electrolyte, form a gastight process gas space. In the case of electrolyte-supported cells, the attachment may take place by means of sintered connections or by application of sealant (e.g. glass solder).

“Gastight” in connection with the present invention means in particular that the leakage rate for sufficient gastight status amounts on a standard basis to <10⁻³ hPa*dm³/cm² s (hPa: hectopascal, dm³: cubic decimetre, cm²: square centimetre, s: second) (measured under air by pressure increase method using the Integra DDV instrument from Dr. Wiesner, Remscheid, at a pressure difference dp=100 hPa).

The housing extends on at least one side of the electrochemical cell unit beyond the region of the electrochemical cell unit and forms, as a sub-space of the process gas space, a process gas conduction space which is open to the electrochemical cell unit. The process gas space is therefore subdivided (theoretically) into two sub-regions, into an inner region directly below the layer construction of the electrochemical cell unit, and into a process gas conduction space surrounding the inner region.

In the region of the process gas conduction space there are gas passage openings made in the housing that serve for the supply and/or removal of the process gases. The gas passage openings may be integrated, for example, into the edge region of the interconnector and in housing parts such as circumscribing frame panels.

The supply of the electrochemical cell unit in the inner region of the process gas space takes place by means of distribution structures which are preferably integrated into the interconnector. The interconnector is preferably configured by an appropriately shaped, metallic sheet part, which for example has a knob-shaped, rib-shaped or wave-shaped design.

In the operation of the electrochemical module as an SOFC, the anode is supplied with fuel (for example hydrogen or conventional hydrocarbons, such as methane, natural gas, biogas, etc., optionally having been fully or partly reformed beforehand) via the gas passage opening and distribution structures of the interconnector, and this fuel is oxidized catalytically there, giving off electrons. The electrons are guided out of the fuel cell and flow via an electrical consumer to the cathode. At the cathode, an oxidant (oxygen or air, for example) is reduced through acceptance of the electrons. The electrical circuit is closed by the flow of the oxygen ions formed at the cathode via the electrolyte—in the case of an electrolyte conductive for oxygen ions—to the anode, and reaction with the fuel at the corresponding interfaces.

In the operation of the electrochemical module as a solid oxide electrolysis cell (SOEC), a redox reaction is forced using electrical current—for example, a conversion of water into hydrogen and oxygen. The construction of the SOEC corresponds essentially to the construction of an SOFC as outlined above, with the roles of cathode and anode being switched. A reversible solid oxide fuel cell (R-SOFC) can be operated either as an SOEC or as an SOFC.

Provided in accordance with the present invention is a molding which is designed as a separate component from the electrochemical cell unit and the housing. The molding is produced by powder metallurgy and is therefore porous or at least sectionally porous, if aftertreated by pressing or local melting, for example, at the edge and/or on the surface. Through the use of a porous molding it is possible to make a decisive weight saving relative to a solid part, while obtaining comparable mechanical properties. The molding is preferably flat and possesses a flat body having one plane of principal extent. In accordance with the invention, the molding is adapted for arrangement within the process gas conduction space; in other words, its shape is adapted to the interior of the process gas conduction space. In the operation of the electrochemical module, the molding is arranged within the process gas conduction space, advantageously completely in the process gas conduction space, i.e. completely in the process gas space outside the region directly below the layer construction of the electrochemical cell unit.

The molding advantageously lies with its topside against an upper housing part of the process gas conduction space and with its bottom side against a lower housing part of the process gas conduction space. The thickness of the molding therefore corresponds here to the space internal height of the process gas conduction space. The upper and lower housing walls are consequently supported in the region of the process gas conduction space along the stack direction.

The use of this molding for an electrochemical module is advantageous in a number of respects.

As an important task, the molding fulfils a mechanical support function. As already indicated above, the flat molding is a spacer and acts as a support element, preventing the edge region of the housing from being compressed under application of a pressing pressure. The molding is therefore able to accommodate mechanical loads in the vertical direction (in the stack direction of the electrochemical modules), of the kind occurring during the stacking and subsequent pressing of the individual modules to form a stack, and of transmitting these loads to an adjacent module.

The molding, moreover, produces mechanical reinforcement of the edge region of the electrochemical module. In view of the flat design of the molding, the flexural and torsional stiffness of the housing edge region is increased significantly and so the housing edge region is protected from instances of deflection or other deformations. In the edge region of the module it is possible, as a result, to avoid additional stresses on the weld seams or on other connecting points—for example, soldered or sintered connecting points—between the individual housing parts and/or the electrochemical cell unit, which in practice frequently represent weak points in terms of the gastight status.

In addition to these mechanical functions, the molding, in advantageous developments, serves for improving the guidance of gas within the process gas conduction space. In order to optimize the guidance of gas, there may be gas guide structures designed in the molding, to convey the gas flowing in through the gas passage openings into the inner region of the process gas space, to the gas guide structures of the interconnector, and, respectively, to conduct outflowing gas from the inner region of the process gas space to the gas passage openings which lead out. The gas guide structures here may differ in design according to whether the molding is to fulfil a gas distributor function or a gas collector function.

In one preferred embodiment, continuous gas passage openings are integrated into the molding. The molding here is oriented within the electrochemical module in such a way that the gas passage openings of the molding open out into the gas passage openings of the process gas conduction space (housing) and a vertically continuous gas channel is formed within the stack. To enable a flow of gas to the electrochemical cell unit, the molding is gas-permeable at least in one direction in the plane of principal extent from the gas passage opening up to a side edge facing the inner process gas space. For this purpose, the molding, generally or at least in this direction, may have an open, continuous porosity. In order to optimize the gas flow, the gas permeability (porosity) of the molding may vary spatially here and may be adjusted accordingly by means, for example, of a gradation in the porosity or of local differences in the compaction of the molding (as a result of non-uniform pressing, for example).

Alternatively or in addition, the molding may have at least one channel along the plane of principal extent, thereby permitting an even more directed steering of gas, and a higher gas throughput rate. For better gas distribution and a higher gas throughput rate, a plurality of channels are advantageously provided. The channel or channels are preferably formed superficially and may be incorporated into the surface of the molding by means, for example, of milling, pressing or rolling with corresponding structures. For the purposes of the present specification, a porous molding with a closed porosity and a superficial channel structure which runs from the gas passage opening up to a side edge is also considered to be gas-permeable from the gas passage opening up to the side edge. It is also conceivable for the channel or channels to extend at least sectionally over the entire thickness of the molding, and hence for the channels to be formed not just superficially. A high gas throughput rate is advantageous in the case of this embodiment, but it must be borne in mind that the molding remains a single part and does not fall apart. In order to prevent this, the channels extending over the entire thickness may undergo transition, over their course, into superficial channel structures or porous structures.

In order to improve the flow characteristics, the shape of the channels may be optimized by a variety of approaches:

In one preferred embodiment, the channel or channels extend continuously from the gas passage opening up to the side edge of the molding that is facing the inner process gas space. In this way a high gas throughput rate and a low pressure drop can be achieved.

According to a further embodiment, provision is made in the region of the gas passage opening for the channel or channels to extend radially or substantially radially outward from the gas passage opening. Radially here means that the local tangent to the channel runs in the region of the opening of the channel into the gas passage opening through the centre point of the gas passage opening (geometric median point in the case of non-circular gas passage openings). Substantially radially means that the deviation from exactly radial is a maximum of +/−15°.

In order to obtain uniform flow to or away from the distribution structures of the interconnector in the interior of the process gas space, the channels may open out parallel or substantially parallel to one another in the side edge facing the inner process gas space. Parallel to one another means that at the side edge, the local tangents to the various channels run parallel to one another or—if they are substantially parallel to one another—differ by not more than the angle of +/−10°. At the side edge, the individual channels are preferably equidistant from one another and distributed uniformly over the side edge.

In one advantageous embodiment, as a further measure for uniform distribution and/or removal of the process gases, provision is made, where there are a plurality of channels, for the cross-sectional area of a channel to increase in proportion with the channel length. Accordingly, the greater pressure drop over a longer channel length is compensated by a larger cross-sectional area of the channel.

According to one advantageous, flow-optimized development, a plurality of channels extend in a star shape away from the gas passage opening, and open out into the side edge facing the inner process gas space. The channels which branch off from the gas passage opening originally into a direction facing away from the inner process gas space are in this case redirected in arc shape to the side edge which points in the direction of inner process gas space.

Advantageously, the molding has a plurality of gas passage openings, from which in each case gas guide structures branch off to the side edge of the molding, the edge facing the inner process gas space. This enables efficient and uniform supply to the inner process gas space.

The porous molding may be pressed in gastight manner against the remaining side edge areas, which in the arrangement in the electrochemical cell are not facing the inner process gas space, since no gas flow is needed in these directions in the operation of the electrochemical module.

The molding of the invention is produced separately from the remaining components of the electrochemical module, and is produced preferably by powder metallurgy. The molding is preferably monolithic in design, i.e. made from one piece, which means that it does not comprise a plurality of components connected to one another, even possibly by a fusional join (e.g. soldering, welding, etc.). The production in one piece by powder metallurgy is evident from the microstructure of the molding. Serving as starting material for the production of the molding is a metal-containing powder, preferably a powder of a corrosion-stable alloy such as, for example, a powder of a materials combination based on Cr (chromium) and/or Fe (iron), meaning that the Cr and Fe fraction is in total at least 50% by weight, preferably in total at least 80% by weight, more preferably at least 90% by weight. The molding in this case consists of a ferritic alloy. The molding is produced, preferably by powder metallurgy, in a known way by pressing of the starting powder, optionally with addition of organic binders, and a subsequent sintering operation.

If the molding is used in an MSC, the molding preferably consists of the same material as the support substrate of the MSC. This is advantageous because in this case the thermal expansion is the same and there are no temperature-induced stresses.

The separate architecture and therefore separate fabrication of the molding from the other active elements of the electrochemical cell unit (including the metal substrate in the case of an MSC) has advantages in a number of respects. Firstly, it provides flexibility, and the respective components can be optimized independently of one another for the particular requirement, by establishment of different porosities, for example. Secondly, the production of the electrochemical cell unit is simplified and made more economic, since the unit is less complex, because there is no need also to take account of gas distribution structures at the edge. Thirdly, it also brings with it advantages in the production of the molding, since the molding—unlike the metal substrate of an MSC, which after the sintering operation is additionally coated with the electrochemically active layers—need no longer undergo thermal aftertreatment. The molding can therefore be manufactured with high end-contour accuracy.

As already mentioned, the molding of the invention finds use in an electrochemical module, particularly in an MSC as described for example in EP 2174371 B1. In one preferred embodiment, the electrochemical module has moldings each designed differently for the supplying and removal of the process gases. In this case, the moldings may differ in terms of the material used, their shape, porosity, the shape of the gas guide structures formed, such as the channel structures, etc. For example, in order to prevent backward diffusion, the porosity of the molding used for removing gas may be lower than the porosity of the molding used for supplying gas.

The molding is preferably fixed in the electrochemical module by means of a fusional connection—for example, by being spot-welded on the housing. It may be noted that even in this case, when the molding, on installation into the module, is joined fusionally to another component of the electrochemical cell, it is regarded for the purposes of the present invention as constituting a component formed separately from the electrochemical cell.

In the variant embodiments indicated above, the porous molding has a mechanical support function and serves to improve the flow of gas in the process gas conduction space. In one advantageous development, the porous molding is additionally functionalized on its surface in order to improve its catalytic and/or reactive properties for manipulation of the process gases; in other words, through appropriate functionalization of the surfaces, it is possible to bring about manipulation of the process gases (treatment of the process gases on the reactant side and/or post-treatment on the product side). In the case of functionalization with catalytic and/or reactive properties, the use of a porous molding is advantageous, since the surface which comes into contact with the process gas as it flows past is significantly greater and, correspondingly, more ready to react in the case of a porous component by comparison with a solid component.

In service in an SOFC, for example, the process gas may additionally be reformed on the reactant side by means of the functionalized molding (meaning that the carbon-containing fuel gas is converted into a synthesis gas comprising a mixture of carbon monoxide and hydrogen) and/or can be cleaned to remove impurities such as sulfur or chlorine. On the product side, a molding functionalized appropriately may contribute, for example, to cleaning to remove volatile chromium.

Functionalization of the porous molding may be accomplished by introducing into the material of the molding, and/or applying as a superficial coating, a substance which acts catalytically and/or reactively with the process gas. The catalytic and/or reactive substance may therefore be admixed to the actual starting powder for the production of the sintered molding (“alloyed in”) and/or may be applied to the surface of the molding with the open pores after the sintering operating, by means of a coating procedure. This coating procedure may take place by customary methods known to the skilled person, as for example by means of various deposition methods from the gas phase (physical vapour deposition, chemical vapour deposition), by dip coating (where the component is impregnated or infiltrated with a melt comprising the corresponding functional material), or by means of methods for application of suspensions or pastes (especially for ceramic materials). For the purpose of surface enlargement it is advantageous if the porous surface structure is retained during the coating procedure—that is, the porous surface is not to be overlayered with a top layer, but primarily only the internal surface of the porous structure is to be coated.

When using a molding produced by powder metallurgy from an alloy based on iron and/or chromium, functionalization with the following materials has been found appropriate: used on the reactant side for treating the process gas are the following:

for catalytic reforming of the fuel gas: nickel, platinum, palladium, and oxides of these metals such as NiO;
for cleaning the reactant gas to remove sulfur and/or chlorine: nickel, cobalt, chromium, scandium and/or cerium;
for purifying the reactant gas with respect to oxygen: chromium, copper and/or titanium, with titanium at the same time also possessing a retentive effect relative to carbon.

Used on the product side for post-treatment of the process gas are the following:

getter structures for purification relative to volatile chromium ions: oxidic ceramics such as, for example, Cu—Ni—Mn spinels;
for purifying the product gas with respect to oxygen and preventing backward diffusion: titanium, copper or sub-stoichiometric spinel compounds.

Further advantages of the invention will become apparent from the description hereinafter of exemplary embodiments with reference to the appended figures, in which, for purposes of illustration of the present invention, the size proportions are not always given accurately to scale. In the various figures, the same reference symbols are used for matching components.

Of the figures:

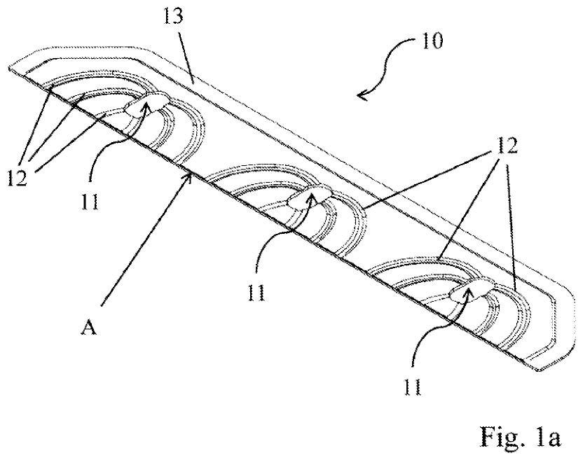

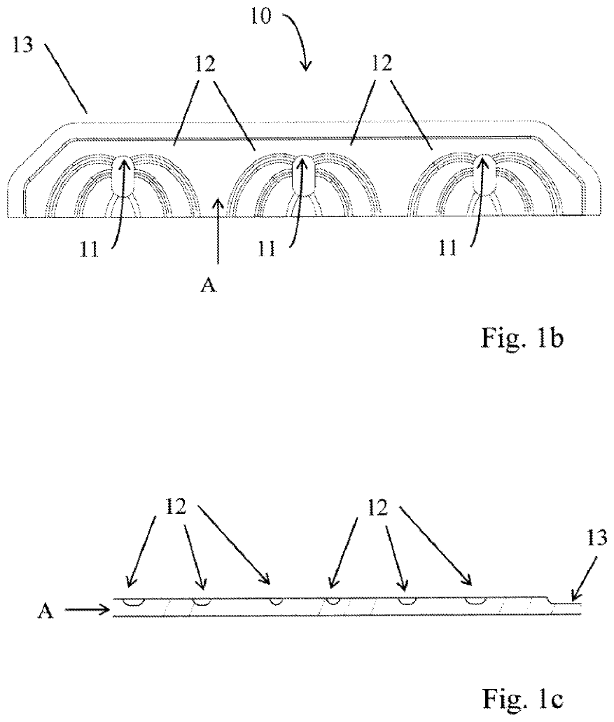

FIG. 1a: shows a first embodiment of a molding for use in an electrochemical module, in perspective view;

FIG. 1b: shows the molding of FIG. 1a in plan view; and

FIG. 1c: shows the molding of FIG. 1a in a side view;

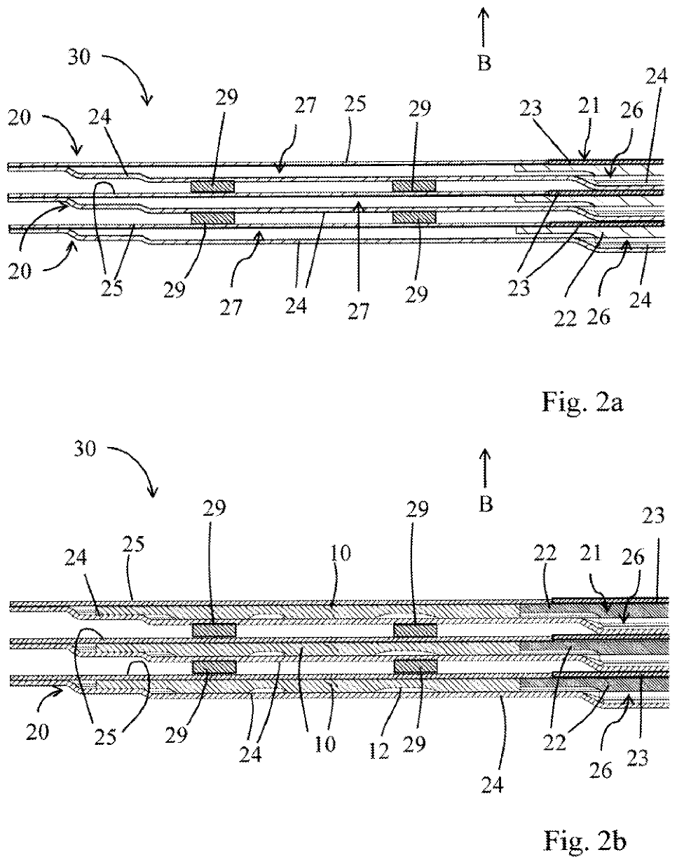

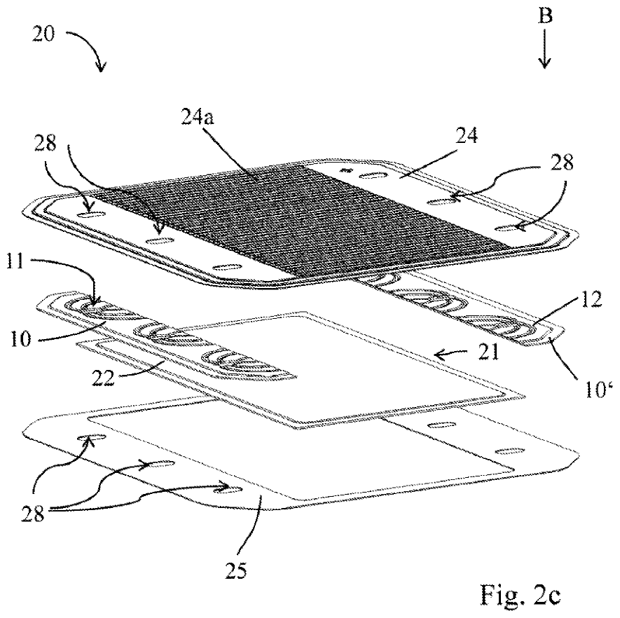

FIG. 2a: shows a stack with three electrochemical modules according to the prior art, without inventive moldings, in cross section;

FIG. 2b: shows a stack with three electrochemical modules each having a molding as per FIG. 1a, in cross section;

FIG. 2c: shows an electrochemical module from FIG. 2b with a molding as per FIG. 1a in an exploded view (here it should be borne in mind that in comparison to the modules in FIG. 2a and FIG. 2b, the electrochemical module in FIG. 2c is shown turned on its head for better visibility of the channels);

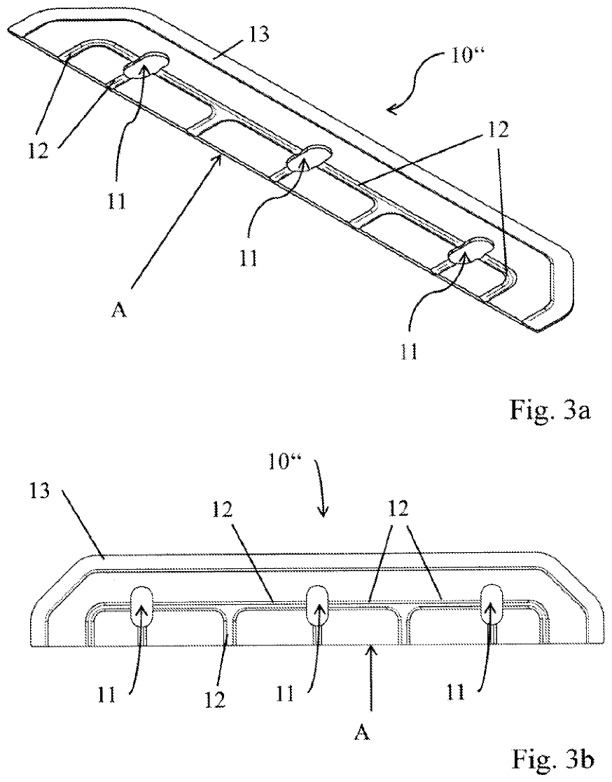

FIG. 3a: shows a second embodiment of a molding for use in an electrochemical module, in perspective view; and

FIG. 3b: shows the molding of FIG. 3a in plan view.

FIG. 1a shows, in perspective representation, a first embodiment of the molding (10) for use in an electrochemical module (20). The arrangement of the molding (10) within the electrochemical module (20) is shown in FIG. 2b and FIG. 2c. FIG. 1b shows the molding (10) in plan view, and it is shown in FIG. 1c in a side view from the side (A), which in the arrangement in the electrochemical module (20) is facing the interior of the process gas space. The molding (10) has been produced by powder metallurgy and is therefore porous. The molding is flat and possesses a flat body with one plane of principal extent. It has a plurality of gas passage openings (11)—in the variant depicted, three central gas passage openings (11)—through which the process gas is supplied and, respectively, removed in the operation of the electrochemical module. Channels (12) extend in a star shape from each of the gas passage openings up to the side edge (A) of the molding, which in the arrangement in the electrochemical module is facing the inner process gas space of the electrochemical module. Channels which branch off from the gas passage opening (11) originally in a direction remote from the inner process gas space are redirected here in an arc shape to the side edge (A) in the direction of inner process gas space. The individual channels (12) extend continuously from the gas passage opening to the side edge (A), thereby enabling efficient gas steering and a low pressure drop within the process gas conduction space.

Additionally, from the gas passage opening (11) in the direction of the side edge (A), the molding (10) has a gas-permeable, open-pored structure (in other words, gas exchange between individual adjacent pores is possible). At the other side edges, the molding is pressed together (13) and in these directions is therefore impermeable to gas.

In operation of the electrochemical module, the process gas flows from the gas passage openings (11) through the channels (12) and the pores to the side edge (A) of the molding, from which it flows on into the interior process gas space. The flow of gas may also be in the opposite direction.

The number and geometry of the channels are optimized to maximize uniformity of supply to the inner process gas space. For this purpose, at the side edge (A), the distances between adjacent channels are approximately equal, and when they open out, therefore, the channels are distributed uniformly over the side edge. Moreover, in the present exemplary embodiment, the channels at the side edge (A) open out approximately at right angles; in this region, therefore, the channels run substantially parallel to one another locally.

As can be seen from FIG. 1c, the channels are made superficially and vary in their cross-sectional area. The cross-sectional area of a channel is substantially constant over its length, but is selected to be larger in line with the length of the channel from the gas passage opening (11) up to the side edge (A). This as well is a measure for achieving maximum uniformity of flow to and removal from the distribution structures of the interconnector in the interior of the process gas space.

FIG. 2a shows a stack with three electrochemical modules according to the prior art, without the inventive molding. The arrangement of the molding in an electrochemical module (20) is shown in FIG. 2b and FIG. 2c. FIG. 2a and FIG. 2b each show, in a schematic representation, a cross section through a stack (30) with three electrochemical modules (20) stacked on top of one another. The electrochemical modules (20) each have an electrochemical cell unit (21) which consists of a porous, metallic support substrate (22) which has been produced by powder metallurgy, with a layer construction (23) with at least one electrochemically active layer applied on this substrate (22) in a gas-permeable region. The support substrate (22) with the layer construction (23) is pressed together in a gastight manner at the edge and has a plate-shaped base structure which in variant embodiments, for enlargement of surface area, may also have local curvature—for example, a wave-shaped design—over a smaller length scale. Located on the side of the support substrate (22) that is opposite the layer construction there is in each case an interconnector (24), which in the region where it bears against the support substrate (22) has a rib structure (24a). The longitudinal direction of the rib structure runs here in the cross-sectional plane in FIG. 2a and FIG. 2b. The interconnector (24) extends beyond the region of the electrochemical cell unit (21) and bears at its outer edge against a frame panel (25) circumscribing the electrochemical cell unit. The circumscriptive frame panel (25) is joined in gastight fashion to the electrochemical cell unit (21) at the inner edge, and is joined in gastight fashion to the interconnector (24) at the outer edge, via a circumscriptive welded connection. The frame panel (25) and the interconnector (24) thus form a constituent of a metallic, gastight housing which, with the electrochemical cell unit (21), delimits a gastight process gas space (26). The process gas conduction space (27) is a sub-space of the process gas space (26), and extends over the region outside the region of the electrochemical cell unit (21), and is open in the direction of the electrochemical cell unit (21). In the region of the process gas conduction space there are gas passage openings (28) formed in the housing (frame panel and interconnector) for the supplying and/or removal of the process gases (not shown in FIG. 2a and FIG. 2b, since the section is taken to the side of the gas passage openings). The gas passage openings in the housing (28) and the gas passage openings (11) in the molding are aligned with one another. The conducting of gas within the stack takes place in a vertical direction (stack direction of the stack (B)) by means of corresponding channel structures, which are formed in the region of the gas passage openings customarily by means of separate inlays (29), seals, and also by controlled application of sealant (e.g. glass solder). The channel structures thus sealed connect the process gas conduction spaces of adjacent electrochemical modules, in a vertical direction.

Whereas FIG. 2a depicts the state of the art without molding, FIG. 2b and FIG. 2c show the arrangement of the molding according to FIG. 1a within the process gas conduction space (27) of the electrochemical module (20). It should be borne in mind that in FIG. 2c, in comparison to the modules in FIG. 2a and FIG. 2b, the electrochemical module is shown turned on its head for better visibility of the channels (12). The shape of the molding is adapted to the interior of the process gas conduction space. The molding bears by its topside against the frame panel (25), the upper boundary of the process gas conduction space, and by its bottom side against the interconnector (24), the lower boundary of the process gas conduction space. A flat contact is advantageous in each case, at its topside and/or at its bottom side. It thickness therefore corresponds to the space internal height of the process gas conduction space (27). The channels (12) formed superficially are located on the underside of the molding (10) (in FIG. 2c, the molding is shown turned on its head). As well as the gas guide function in the process gas conduction space, the molding takes on an important mechanical function. It serves to support the housing along the stack direction of the stack (B), so that compression of the housing edge region is prevented when a pressing pressure is applied. Additionally, because of the flat architecture of the molding, the flexural and torsional stiffness of the housing edge region, which consists of a thin frame panel (25) and a thin interconnector (24), is decisively increased and hence the risk of cracking in the weld seams under mechanical loading is reduced. In one advantageous variant embodiment, the molding is spot welded on the housing and fixed accordingly. The moldings (10,10′) used for supplying and for removing the process gases are preferably different. Their properties (material, shape, porosity, geometry of the channel structures, etc.) may be optimized independently of one another for their intended use.

FIG. 3a shows, schematically, a perspective view, and FIG. 3b the plan view, of a further variant embodiment of the molding. In this variant embodiment, the individual gas passage openings (11) of the molding are in communication with one another through additional channels. This channel structure contributes to additional gas equalization.

1-15. (canceled)

16. A molding for an electrochemical module,
the electrochemical module having:
at least one electrochemical cell unit with a layer construction that includes at least one electrochemically active layer, and
a metallic, gastight housing forming a gastight process gas space with the electrochemical cell unit,
the housing, on at least one side thereof, extending beyond the electrochemical cell unit and forming a process gas conduction space that is open to the electrochemical cell unit, and having at least one gas passage opening in a region of the process gas conduction space for supplying and/or removing the process gases;
the molding being porous, or at least sectionally porous, and being a separate component of the electrochemical cell unit configured for arrangement within the process gas conduction space and also for support of the housing on both sides along a stack direction of the electrochemical module.

17. The molding according to claim 16, wherein the molding is formed with at least one gas passage opening.

18. The molding according to claim 17, wherein the molding is gas-permeable at least in one direction in a plane of principal extent from the gas passage opening up to a side edge of the molding.

19. The molding according to claim 18, wherein a gas permeability of the molding is effected by an open-pored structure of the molding.

20. The molding according to claim 17, wherein the molding is formed with at least one channel along a plane of principal extent.

21. The molding according to claim 20, wherein the at least one channel extends continuously from the gas passage opening up to a lateral edge.

22. The molding according to claim 20, wherein the at least one channel extends radially or substantially radially outwards from the gas passage opening in a region of the gas passage opening.

23. The molding according to claim 20, wherein the at least one channel is one of a plurality of channels that open out into a side edge parallel or substantially parallel to one another.

24. The molding according to claim 20, wherein the at least one channel is one of a plurality of channels and a cross-sectional area of the channels increases proportionally with a channel length.

25. The molding according to claim 20, wherein the at least one channel extends at least sectionally over an entire thickness of the molding.

26. The molding according to claim 16, wherein the molding is formed of a ferritic alloy produced by powder metallurgy and based on at least one of iron and/or chromium.

27. In combination with an electrochemical module, the molding according to claim 16 disposed in the process gas conduction space of the electrochemical module.

28. An electrochemical module, comprising:
a substantially plate-shaped electrochemical cell unit having a layer construction with at least one electrochemically active layer; and
a metallic, gastight housing defining a gastight process gas space together with said at least one electrochemical cell unit, said housing, on at least one side thereof, extending beyond said electrochemical cell unit and forming a process gas conduction space that is open to the at least one electrochemical cell unit, and having at least one gas passage opening in a region of said process gas conduction space for a supply and/or a removal of process gases; and
at least one molding according to claim 16 disposed within said process gas conduction space, in a region of said gas passage openings, said at least one molding serving to support said housing along a stack direction of the electrochemical module.

29. The electrochemical module according to claim 28, wherein said layer construction is arranged on a first side, facing away from the process gas space, of a substantially plate-shaped, metallic support substrate which is porous at least in a region of said layer construction.

30. The electrochemical module according to claim 29, wherein the gastight housing is formed of at least one frame panel circumscribing said support substrate, and of an interconnector, said frame panel having an inner edge joined gastightly to said electrochemical cell unit and an outer edge joined gastightly to said interconnector via a circumscribing welded connection.

31. An electrochemical module assembly, comprising:
at least one electrochemical cell unit having a layer construction with at least one electrochemically active layer, the electrochemical cell unit defining a stack direction of the electrochemical module;
a metallic, gastight housing forming a gastight process gas space together with said electrochemical cell unit;
said housing, on at least one side thereof, extending beyond said electrochemical cell unit and forming a process gas conduction space that is open to the electrochemical cell unit, and having at least one gas passage opening for supplying process gas to and/or removing process gas from said process gas conduction space;
a porous, or at least sectionally porous molding being a separate component of said electrochemical cell unit, said molding being configured for arrangement within said process gas conduction space and also to support said housing on both sides along the stack direction of the electrochemical module.

32. The module according to claim 31, wherein said molding is formed with at least one gas passage opening.
